(19) United States
(12) Patent Application Publication
(10) Pub. No.: US 2007/0138936 A1
(43) Pub. Date: Jun. 21, 2007

(54) Flat-type lamp plate structure

(75) Inventor: Chih-Chun Chang, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/311,580

(22) Filed: Dec. 15, 2005

(51) Int. Cl. H01J 1/62

(52) U.S. Cl. 313/493

(57) ABSTRACT

A plurality of flat-type lamp plate structures are separately arranged in one or multi-dimensional array to correspond to single back plate or diffuse plate. Each supporter with stacked inlaid portions is inserted between any two of the flat-type lamp plate structures to not only constrain the flat-type lamp plate structures but also support the back plate, diffuse plate and flat-type lamp plate structures.

### BACKGROUND OF THE INVENTION

1. Field of the Invention

The present invention relates to a flat-type light source plate, and more especially, to a flat type lamp applied to a backlight and a flat light source of a liquid crystal display (LCD).

2. Background of the Related Art

Recently, research of the flat panel display has been actively pursued. For examples, liquid crystal displays (LCD), field emission displays (FED), electro luminescence displays (ELD) and plasma display panel (PDP) have been attracted considerable attention. Among the flat panel displays, LCD is unlike to the other flat panel displays mentioned above because LCD display does not emit light. Thus, a separate light source is assigned as the backlight to the LCD display. For large-scale flat panels, a flat-type light source plate that irradiates uniform light, enhances the performance of the backlight and simplifies the combination of the assembly is a preference rather than the traditional CCFL fluorescent tub.

Nevertheless, the size of the flat type lamp increases with the development of the large panel display. Thus, the heavy weight and area of the flat-type light source plate raises some issues: (1) it occupies much space and is inconveniently transported; (2) it becomes hard to control inspection; (3) the deformation is formed. Special supporters are designed to prevent the panel from sag. Problems about manufacturing, combination and transportation have been occurring as mentioned above for a larger flat panel. It is important to solve those problems on development of the large-scale panel.

SUMMARY OF THE INVENTION

In order to solve the problems mentioned above, the present invention provides a flat-type lamp plate structure applied to large-scale liquid crystal displays. Multitudes of flat-type light source plate units cooperate to correspond to a large panel display, so that each flat-type light source plate unit is small, easily made and inspected.

The assembly of display panels with large size is improved by providing a flat-type light source plate with some units arranged in array and fixed by inserting spacer pins to be a lamp device with large size.

The sag issue on a diffuse plate is resolved by providing a fixing structure applied to flat-type light source plate. Two spacer pins engaged with each other are capable of fixing and positioning the flat-type light source plates, so as to enhance the accuracy of assembly and provide the diffuse plate with supporting.

Accordingly, a plurality of flat-type light source plate units coplanar and separately arranged in one or two-dimensional array provides a large-scale flat-type light source plate corresponding to a back or diffuse plate according to an embodiment of the present invention. The design of stacked engaged spacer pins to form a supporter is through any two of flat-type light source plates. First spacer pin with an extension portion is extruded out of one side of a flat-type light source plate unit and second spacer pin with a receiving portion is extruded out of another side, wherein the extension portion of the first spacer pin inserts through the interstice of two adjacent flat-type light source plate and inlays to the receiving portion of second spacer pin to constraint, fix and support the assembly of a back plate, diffuse plate and flat-type light source plate.

### BRIEF DESCRIPTION OF THE DRAWINGS

FIG. 1 is a cross-sectional view of the flat-type light source plate unit of an embodiment of the invention.

FIGS. 2A, 2B, 2C, 2D and FIG. 2E are top views of the array of the flat-type light source plate units of an embodiment of the invention.

FIG. 3A and FIG. 3B are perspective views of the first and second spacer pins of one supporter of an embodiment of the invention respectively.

FIG. 4 is a cross-sectional view of an embodiment of the invention, which are composed of a back plate, a flat-type light source plate unit, a supporter and a diffuse plate.

### DETAILED DESCRIPTION OF THE INVENTION

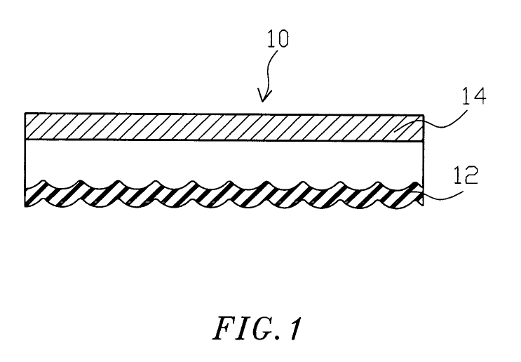

FIG. 1 is a cross-sectional view illustrating a flat-type light source plate unit in accordance with an embodiment of the present invention. In the embodiment, the flat-type light source plate unit 10 includes first substrate 12 and second substrate 14 opposing to each other. The cathode and the anode electrodes are set in an enclosed space formed between the first substrate 12 and the second substrate 14 to produce the discharge gas charged between the two substrates. It is appreciated that the flat-type light source plate unit also includes a side-wall around the first substrate 12 and the second substrate 14. Furthermore, the shapes of the first substrate 12 and the second substrate 14, not limited, may be curved or flat. Furthermore, the first substrate 12 and the second substrate 14 may be made of transparent material, glass or the heat-resistant material with diffractive characteristic. Moreover, the shape of the flat-type light source plate unit 10, not limited to, may be a rectangle, a parallelogram, a square or even the other shape enabling to be manufactured and all should not limit the scope of the invention.

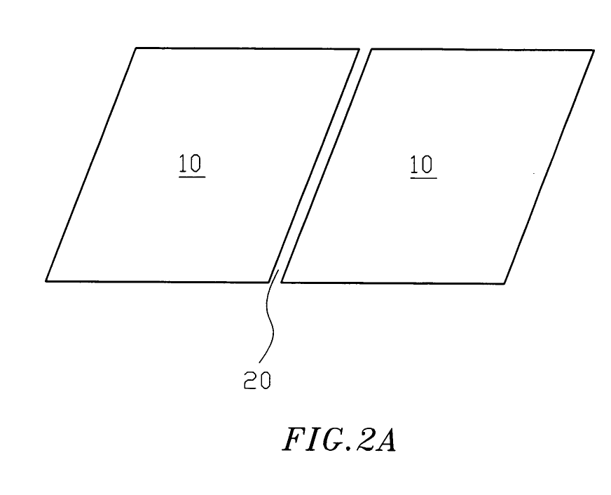

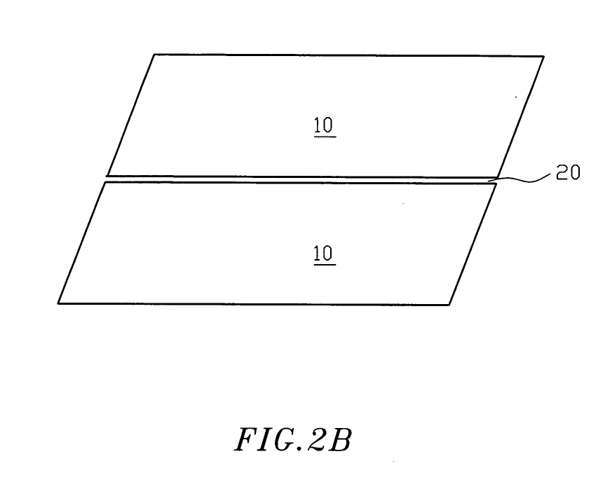

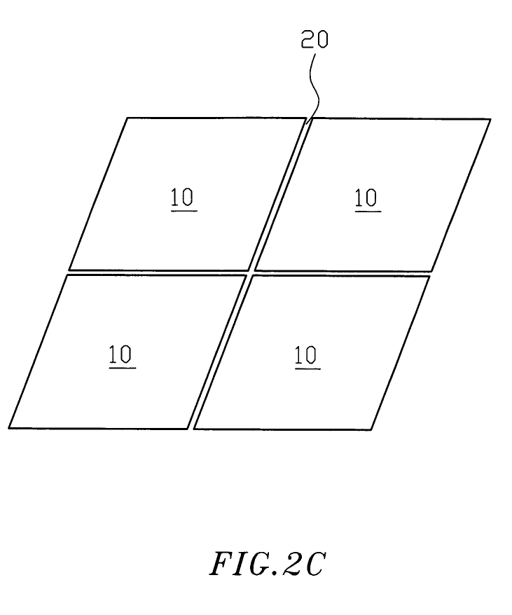

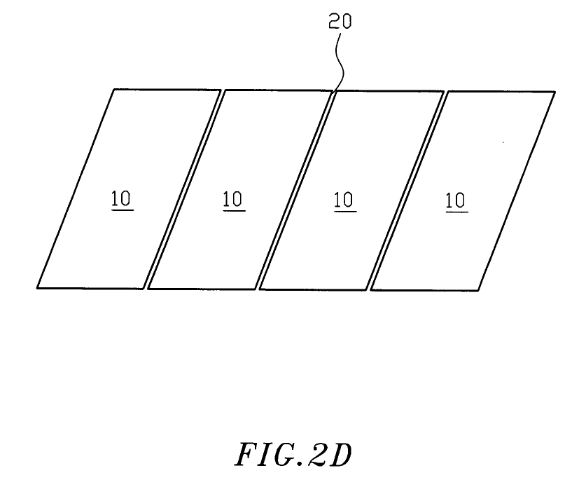

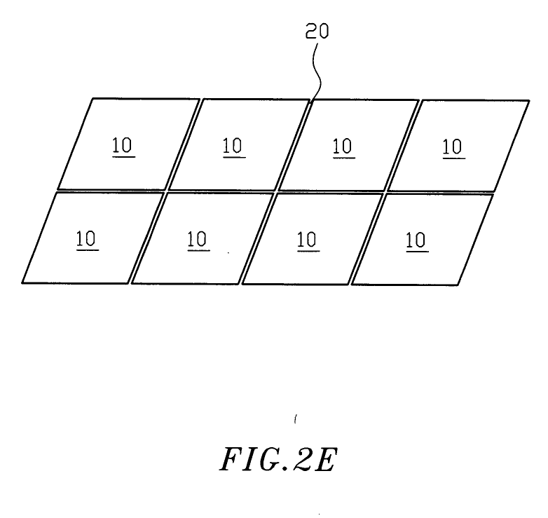

FIG. 2A to FIG. 2E are schematically top views illustrating different arrangements of the flat-type light source plate units in accordance with various embodiments of the present invention. A flat-type light source plate composed of a plurality of flat-type light source plate units 10 corresponds to a flat panel display. In one embodiment, the flat-type light source plate units 10 in the same size and shape are coplanar arranged in a rank or an array. A gap 20 is retained between two adjacent flat-type light source plate units 10, that is, the plurality of flat-type light source plate units 10 is arranged separately. It is understandable that the flat-type light source plate units 10 may have different sizes and shapes in different embodiments according to the invention. It is noted that the gap 20 may have the same or various widths. Furthermore, the width of the gap 20 is not limited as long as it does not influence the performance of the flat-type light source plate and flat panel display.

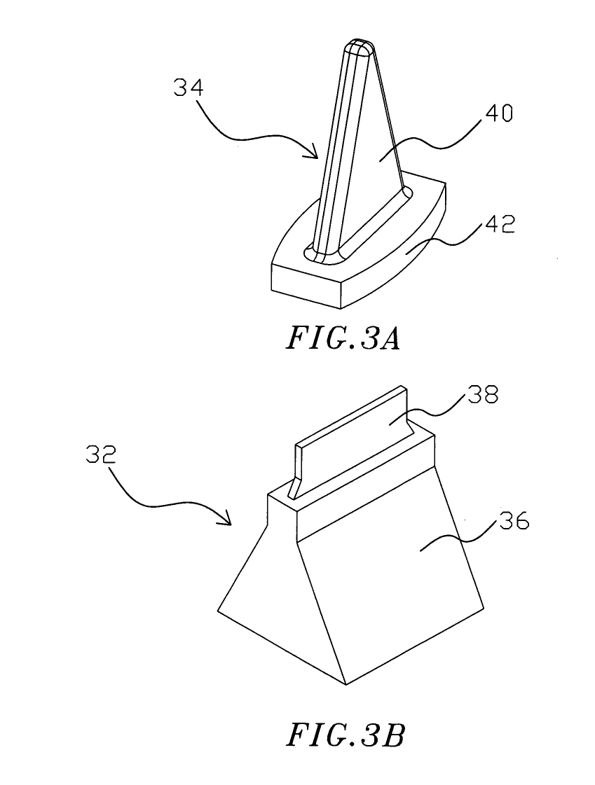

As mentioned above, the flat-type light source plate corresponding to a flat panel display is composed of a plurality of flat-type light source plate units according to an embodiment of the invention. One of features of the present invention is to simplify the manufacturing process, to easily control the qualities and to enhance the yield rate. Another feature is the gap 20 between two flat-type light source plate units 10 and a specific supporter designed for supporting the light diffuse plate. FIG. 3A and FIG. 3B are schematic diagrams illustrating a supporter according to the present invention. In the embodiment, a supporter includes a first spacer pin 32 in FIG. 3B and second spacer pin 34 in FIG. 3A stacked each other. Referring to the FIG. 3A, the second spacer pin 34 includes a base 40 and a receiving portion 42 fixed on the base 40. The receiving portion 42 includes a space (not shown) configured to contain and engage the portion of the extension portion 38. Refer to the FIG. 3B, the first spacer pin 32 includes a base 36 and an extension portion 38 fixed on the base 36. In one embodiment, the shape and size of the extension portion 38 is designated for and dependent on the gap width. The extension portion 38 may be insert into the gap between two flat-type light source plate units. The junction area of the extension portion 38 and the base 36 is smaller than the surface of the base 36. In this embodiment, the engagement of the first spacer pin 32 and the second spacer pin 34 is capable of fixing and supporting the flat-type light source plate units and the diffuse plate. Furthermore, the first spacer pin 32 and the spacer pin 34 may be made of a transparent material, glass or heat-resistant material with diffractive characteristic.

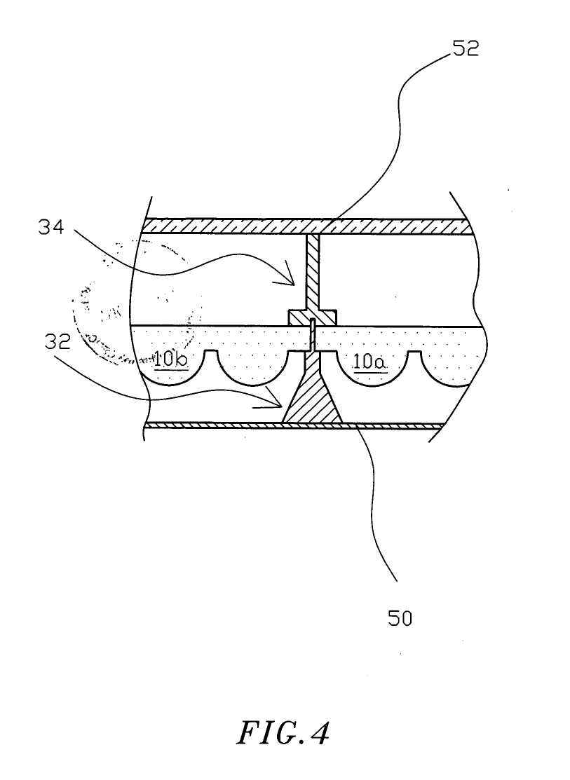

FIG. 4 is a cross-sectional view illustrating the assembly of a back plate, flat-type light source plate units, supporter and light-diffuse plate in accordance with one embodiment of the invention. As the drawing shown, flat-type light source plate units 10a and 10b, separated by the combination of first spacer pin 32 and second spacer pin 34, are coplanar arranged between the back plate 50 and the diffuse plate 52. Moreover, the flat-type light source plate units 10a and 10b are smaller than either the back plate 50 or diffuse plate 52. The first spacer pin 32 and second spacer pin 34 are stacked and engaged each other by inserting the extension portion 38 of the first spacer pin 32 into the receiving portion 42 of the second spacer pin 34 to fix the flat-type light source plate units 10a and 10b. That is, the first spacer pin 32 with the base 36 stands on one side of the flat-type light source plate units 10a and 10b and with the extension portion 38 inserts between the flat-type light source plate units 10a and 10b to fix them. It is understandable that the first spacer pin 32 is positioned between the flat-type light source plate units 10a, 10b and the diffuse plate 52 as well, and the second spacer pin 34 is between the flat-type light source plate units 10a, 10b and the back plate 50. That is, the width of the gap between the flat-type light source plate units 10a and 10b is provided for setting or holding a spacer bin. Accordingly, the objects of the present invention are achieved by the stacked combination of the first spacer pin 32 and the second spacer pin 34.

Accordingly, one of features is the combination of flat-type light source plate units with suitable sizes cooperated with supporters by suitable amount to enhance the assembly and efficient inspection. Furthermore, another feature of the present invention is to fix and support the flat-type light source plate units with the supporters inserted therebetween. It is noted that the amount of the gap increases with one of the flat-type light source plate units. Thus, a reflective or diffractive film may be applied to the inner surface of the diffuse plate and/or back plate corresponding to the gaps to enhance diffractive light. It is appreciated that the reflective or diffractive film may be applied to the whole surface of the diffuse plate and/or back plate.

Although the present invention has been explained in relation to its preferred embodiment, it is to be understood that other modifications and variation can be made without departing the spirit and scope of the invention as hereafter claimed.

What is claimed is:

1. A flat-type light source plate structure comprising:
a plurality of flat-type light source plate units positioned in coplanar arrangement; and
a plurality of supporters, wherein any one of the supporters inserts through a gap between any two adjacent of flat-type light source plate units.

2. The flat-type light source plate structure according to claim 1, wherein any one of the flat-type light source plate units includes a first substrate, a second substrate and a side-wall between the first and the second substrates to form an enclosed space.

3. The flat-type light source plate structure according to claim 1, wherein any one of the supporters comprises:
a first spacer pin extruded out of one surface of any one of the flat-type light source plate units, wherein the first spacer pin has an extension portion; and
a second spacer pin extruded out of the other surface of the flat-type light source plate unit, wherein the second spacer has a receiving portion with which the extension portion passing through the gap is engaged.

4. The flat-type light source plate structure according to claim 3, wherein the first spacer pin further comprises a base fixed on the extension portion and extruded out of the surface of the flat-type light source plate unit.

5. The flat-type light source plate structure according to claim 3, wherein the second spacer pin further comprises a base fixed on the receiving portion and extruded out of the other surface of the flat-type light source plate unit.

6. A flat-type light source plate structure comprising:
a diffuse plate;
a back plate;
a plurality of flat-type light source plate units separately and coplanar arranged between the diffuse plate and the back plate; and
a plurality of supporters distributed between the diffuse plate and the back plate and inserted into any two adjacent flat-type light source plate units.

7. The flat-type light source plate structure according to claim 6, wherein any one of the flat-type light source plate units includes a first substrate, a second substrate and a side-wall between the first and the second substrates to form an enclosed space.

8. The flat-type lamp plate structure according to claim 6, wherein any one of the supporters includes a first spacer pin separating the diffuse plate and the plurality of flat-type light source plate units and including an extension portion separating any two adjacent flat-type light source plate units.

9. The flat-type lamp plate structure according to claim 8, wherein any one of the plurality of supporters further comprises a second spacer pin separating the back plate and the plurality of flat-type light source plate units and including a receiving portion engaged with the extension portion.

10. The flat-type lamp plate structure according to claim 6, any one of the supporters includes a first spacer pin separating the back plate and the plurality of flat-type light source plate units and including an extension portion separating any two adjacent flat-type light source plate units.

11. The flat-type lamp plate structure according to claim 10, wherein any one of the plurality of supporters further comprises a second spacer pin separating the diffuse plate and the plurality of flat-type light source plate units and including a receiving portion engaged with the extension portion.

12. The flat-type lamp plate structure according to claim 6, wherein any one of the plurality of flat-type light source plate units is smaller than the back plate.

13. The flat-type lamp plate structure according to claim 6, wherein any of the plurality of flat-type light source plate units is smaller than the diffuse plate.

14. The flat-type lamp plate structure according to claim 6, wherein a reflective film is atop the surface of the back plate facing the flat-type light source plate units.

15. The flat-type lamp plate structure according to claim 6, wherein a diffractive film is atop the diffuse plate facing the flat-type light source plate units.

16. A supporter employed for fixing and supporting a plurality of flat-type lamp plate structures of a flat panel display, the supporter comprising:
a first spacer pin with an extension portion and a first base fixed atop the extension portion; and
a second spacer pin with a receiving portion and a second base fixed atop the receiving portion, wherein the extension portion is inserted between any two adjacent flat-type light source plate units and engage with the receiving portion.

17. The supporter according to claim 16, wherein the first and the second bases are extruded out of the opposite surfaces of the flat-type light source plate units, respectively.

18. An assemble structure comprising a plurality of flat-type light source plate units corresponding to a back plate of a flat display, wherein each one of the flat-type light source plate units is smaller than the back plate and separated coplanar arranged in an array of one or two dimensions.

19. The assemble structure according to claim 18, wherein any one of the flat-type light source plate units includes a first substrate, a second substrate and a side-wall between the first and the second substrates to form an enclosed space.

20. The assemble structure according to claim 19, wherein the first and the second substrates are in a flat or curved shape.
